(19) United States
(12) Patent Application Publication
(10) Pub. No.: US 2018/0151061 A1
(43) Pub. Date: May 31, 2018

(54) Wrist-worn device for operating multiple remote-controlled devices and other functions wirelessly and without a need to be in communication with a smart phone and the like

(71) Applicant: Givi LAUREN, Forest Hills, NY (US)

(72) Inventor: Givi LAUREN, Forest Hills, NY (US)

(21) Appl. No.: 15/530,049

(22) Filed: Nov. 25, 2016

(51) Int. Cl. G08C 17/02; G08B 17/10; G08B 21/14; G06F 19/00; G09B 21/00

(52) U.S. Cl. CPC G08C 17/02; G08B 17/10; H04N 2005/443; G06F 19/323; G09B 21/003; G08B 21/14

(57) ABSTRACT

A wrist-worn device that is worn around a wrist of a user and operates multiple remote-controlled devices and other functions wirelessly and without a need to be in communication with a smart phone and the like. The wrist-worn device includes a band, multiple remote-controlled device activators, other functionalities, and a display. The band is worn around the wrist of the user. The multiple remote-controlled device activators are disposed at the band and operate the multiple remote-controlled devices wirelessly and without the need to be in communication with the smart phone and the like. The other functionalities are disposed at the band and operate the other functions wirelessly and without the need to be in communication with the smart phone and the like. The display is disposed at the band.

### BACKGROUND OF THE INVENTION

### Field of the Invention

The embodiments of the present invention relate to a wrist-worn device, and more particularly, the embodiments of the present invention relate to a wrist-worn device for operating multiple remote-controlled devices and other functions wirelessly and without a need to be in communication with a smart phone and the like.

### Description of the Prior Art

Numerous innovations for wrist-worn devices have been provided in the prior art. Even though these innovations may be suitable for the specific individual purposes to which they address, nevertheless, they differ from the embodiments of the present invention in that they do not teach a wrist-worn device for operating multiple remote-controlled devices and other functions wirelessly and without a need to be in communication with a smart phone and the like, for example:
U.S. Pat. No. 7,102,507 to Lauren Incorporated Herein its Entirety by Reference Thereto

U.S. Pat. No. 7,102,507 issued to Lauren on Sep. 5, 2006 teaches a device for wearing on the wrist of a user and being capable of operating multiple remote controlled devices. The device includes a band, a remote control transmitter, and a plurality of buttons. The band is worn around the wrist of a user. The remote control transmitter is disposed at the band and selectively transmits different signals. Each signal selectively transmitted by the remote control transmitter is received by a specific receiver operatively connected to a remote controlled device, and when the specific receiver receives an associated signal, the remote controlled device operatively connect thereto operates. The plurality of buttons are disposed at the band and are operatively connected to the remote control transmitter. Each button is associated with a specific signal so as to allow the specific signal to be transmitted when an associated button is activated.

It is apparent that innovations for wrist-worn devices have been provided in the prior art, which are adapted to be used. Furthermore, even though these innovations may be suitable for the specific individual purposes to which they address, nevertheless, they would not be suitable for the purposes of the embodiments of the present invention as heretofore described, namely, a wrist-worn device for operating multiple remote-controlled devices and other functions wirelessly and without a need to be in communication with a smart phone and the like.

### SUMMARY OF THE INVENTION

Thus, it is an object of the embodiments of the present invention to provide a wrist-worn device for operating multiple remote-controlled devices and other functions wirelessly and without a need to be in communication with a smart phone and the like, which avoids the disadvantages of the prior art.

Briefly stated, another object of the embodiments of the present invention is to provide a wrist-worn device that is worn around a wrist of a user and operates multiple remote-controlled devices and other functions wirelessly and without a need to be in communication with a smart phone and the like. The wrist-worn device includes a band, multiple remote-controlled device activators, other functionalities, and a display. The band is worn around the wrist of the user. The multiple remote-controlled device activators are disposed at the band and operate the multiple remote-controlled devices wirelessly and without the need to be in communication with the smart phone and the like. The other functionalities are disposed at the band and operate the other functions wirelessly and without the need to be in communication with the smart phone and the like. The display is disposed at the band.

The embodiments of the present invention themselves, however, both as to their construction and to their method of operation together with additional objects and advantages thereof will be best understood from the following description of the specific embodiments when read and understood in connection with the sole FIGURE of the drawing.

### BRIEF DESCRIPTION OF THE FIGURE OF THE DRAWING

The sole FIGURE of the drawing is a diagrammatic block diagram of the wrist-worn device of the embodiments of the present invention.

### LIST OF REFERENCE NUMERALS UTILIZED IN THE FIGURE OF THE DRAWING

### Introductory

10 wrist-worn device of embodiments of present invention for wearing around wrist 12 of user 14 and for operating multiple remote-controlled devices 16 and other functions 18 wirelessly and without need to be in communication with smart phone and like 20
12 wrist of user 14
14 user

### Overall Configuration of Wrist-Worn Device 10

22 band for wearing around wrist 12 of user 14
24 multiple remote-controlled device activators for operating multiple remote-controlled devices 16 wirelessly and without need to be in communication with smart phone and like 20
26 other functionalities for operating other functions 18 wirelessly and without need to be in communication with smart phone and like 20
27 display
30 touch screens of display 27

### DETAILED DESCRIPTION OF THE PREFERRED EMBODIMENTS

### Introductory

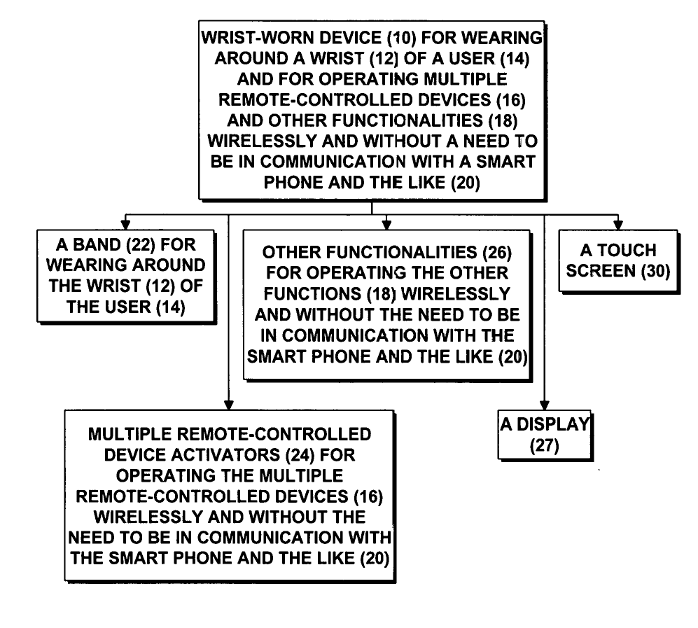

Referring now to the FIGURES, and particularly to FIG. 1, the wrist-worn device of the embodiments of the present invention is shown generally at 10 for wearing around a wrist 12 of a user 14 and for operating multiple remote-controlled devices 16 and other functions 18 wirelessly and without a need to be in communication with a smart phone and the like 20.

### Overall Configuration of the Wrist-worn Device 10

The wrist-worn device 10 comprises a band 22, multiple remote-controlled device activators 24, other functionalities 26, and a display 27. The band 22 is for wearing around the wrist 12 of the user 14. The multiple remote-controlled device activators 24 are disposed at the band 22 and are for operating the multiple remote-controlled devices 16 wirelessly and without the need to be in communication with the smart phone and the like 20. The other functionalities 26 are disposed at the band 22 and are for operating the other functions 18 wirelessly and without the need to be in communication with the smart phone and the like 20. The display 27 is disposed at the band 22 and contains touch screens 30.

The band 22 is waterproof for protecting the multiple remote-controlled device activators 24, the other functionalities 26, and the display 27 from any water damage.

### Specific Configuration of the Multiple Remote-Controlled Device Activators 24

The multiple remote-controlled device activators 24 utilize at least one of buttons, the touch screens 30 of the display 27, and combinations thereof to activate.

The multiple remote-controlled device activators 24 include a lock and unlock function.

The lock and unlock function of the multiple remote-controlled device activators 24 is for selectively locking and unlocking multiple locks using only one device, namely, the wrist-worn device 10, by a mere touching of the at least one of the buttons of the multiple remote-controlled device activators 24, the touch screens 30 of the display 27, and the combinations thereof.

The multiple locks of the lock and unlock function of the multiple remote-controlled device activators 24 include, by way of example only, at least one door of at least one of a house, an office, a car, a garage, and a gym locker.

The multiple remote-controlled device activators 24 further include an on and off function.

The on and off function of the multiple remote-controlled device activators 24 is for selectively turning on and off multiple devices using only one device, namely, the wrist-worn device 10, by the mere touching of at least one of buttons of the multiple remote-controlled device activators 24, the touch screens 30 of the display 27, and the combinations thereof.

The multiple devices of the on and off function of the multiple remote-controlled device activators 24 include, by way of example only, at least one of at least one TV, at least one computer, at least one AC, and at least one set of curtains.

The on and off function of the multiple remote-controlled device activators 24 further, by way of example only, selectively changes channels and monitors volume of the at least one TV of the on and off function of the multiple remote-controlled device activators 24.

### Specific Configuration of the Other Functionalities 26

The other functionalities 26 utilize the at least one of the buttons, the touch screens 30 of the display 27, and the combinations thereof to activate.

The other functionalities 26 include an enhanced Lifealert® function.

The enhanced Lifealert® function of the other functionalities 26 is for notifying Lifealert®, and additionally and simultaneously, is for notifying a designated person using only the wrist-worn device 10. With today's technology, however, if somebody falls and has Lifealert®, they do not necessarily need to push a button. The speed of the fall and the impact on the ground triggers the Lifealert® to transmit information. In this case, the information will be transmitted to the designated person simultaneously.

The designated person of the other functionalities 26, by way of example only, includes at least one of a family member and a close person, so as to allow the at least one of the family member and the close person of the designated person of the other functionalities 26 to know if the enhanced Lifealert® function of the other functionalities 26 has been activated so as to be able to be on top of any emergency situation immediately when something happens.

The other functionalities 26 further include a medical history function.

The medical history function of the other functionalities 26 includes a port, an internal memory device, and an external memory device. The internal memory device of the medical history function of the other functionalities 26 is for storing updated medical history of the user 14 and previous medical history of the user 14. A remote flash drive would be placed in the wrist-worn device 10, which would be connected to a computer and any added information would go back to the flash drive.

The port of the medical history function of the other functionalities 26 is disposed at the band 22, and is in communication with the internal memory device of the medical history function of the other functionalities 26.

The port of the medical history function of the other functionalities 26 replaceably receives the external memory device of the medical history function of the other functionalities 26 for transferring the updated medical history of the user 14 thereto for interfacing with a computer for viewing of, and for transferring, the updated medical history of the user 14.

The updated medical history of the user 14, by way of example only, includes at least one of EKGs, X-Rays, MRI results, medical diagnoses, medications prescribed, doctor's notes, and progress notes for viewing by a healthcare provider.

The other functionalities 26 further include a tracking/locating function.

The tracking/locating function of the other functionalities 26 is for locating a lost item using only the wrist-worn device 10, by a mere touching of the at least one of the buttons, the touch screens 30 of the display 27, and the combinations thereof.

The lost item of the tracking/locating function of the other functionalities 26 include, by way of example only, at least one of a child, an adult, an IPhone, a wallet, a car that one forgot where the car of the lost item of the tracking/locating function of the other functionalities 26 was parked, and any other significant item.

The other functionalities 26 further include a blind/visually impaired function.

The blind/visually impaired function of the other functionalities 26 have Braille characters thereon for assisting blind/visually impaired.

The other functionalities 26 further include a bio scanner function.

The bio scanner of the other functionalities 26 is for preventing using the wrist-worn device 10 by those not authorized to use the wrist-worn device 10 and is activated by using only the wrist-worn device 10.

The other functionalities 26 further include a smoke detector function.

The smoke detector function of the other functionalities 26 is for notifying when smoke is detected and is automatically activated by using only the wrist-worn device 10 when high levels of smoke are detected.

The other functionalities 26 further include a carbon monoxide detector function.

The carbon monoxide detector function of the other functionalities 26 is for notifying when carbon monoxide is detected and is automatically activated by using only the wrist-worn device 10 when high levels of carbon monoxide are detected.

The other functionalities 26 further include a radiation detector function.

The radiation detector function of the other functionalities 26 is for notifying when radiation is detected and is automatically activated by using only the wrist-worn device 10 when high levels of radiations are detected.

The other functionalities 26 further includes a light function.

The light function of the other functionalities 26 is for illuminating dark and dimly lighted areas and is activated by using only the wrist-worn device 10, by a mere touching of the at least one of the buttons of the other functionalities 26, the touch screens 30 of the display 27, and the combinations thereof.

The other functionalities 26 further includes a watch function.

The watch function of the other functionalities 26 is for displaying time, and is activated by using only the wrist-worn device 10, by a mere touching of the at least one of the buttons of the other functionalities 26, the touch screens 30 of the display 27, and the combinations thereof.

The other functionalities 26 further include a recorder function.

The recorder function of the other functionalities 26 is for recording sound, and is activated by using only the wrist-worn device 10, by a mere touching of the at least one of the buttons of the other functionalities 26, the touch screens 30 of the display 27, and the combinations thereof.

The other functionalities 26 further include an alarm function.

The alarm function of the other functionalities 26 is for activating an alarm connected thereto automatically if security is breached, and is for notifying an owner and law enforcement simultaneously, and is activated by using only the wrist-worn device 10.

The alarm of the alarm function of the other functionalities 26 includes, by way of example only, a car alarm, a home alarm, and any additional alarm and security system connected to the wrist-worn device 10.

The other functionalities 26 further include a radio function.

The radio function of the other functionalities 26 is for playing a radio, is activated by using only the wrist-worn device 10, by a mere touching of the at least one of the buttons of the other functionalities 26, the touch screens 30 of the display 27, and the combinations thereof, and is connected to headphones via an auxiliary port.

The other functionalities 26 further include a recorded book function.

The recorded book function of the other functionalities 26 is for allowing the listening of a recorded book, and is activated by using only the wrist-worn device 10, by a mere touching of the at least one of the buttons of the other functionalities 26, the touch screens 30 of the display 27, and the combinations thereof.

The other functionalities 26 further include a timer function.

The timer function of the other functionalities 26 is for keeping track of time, and is activated by using only the wrist-worn device 10, by a mere touching of the at least one of the buttons of the other functionalities 26, the touch screens 30 of the display 27, and the combinations thereof.

The other functionalities 26 further include a compass function.

The compass function of the other functionalities 26 is for providing a compass, and is activated by using only the wrist-worn device 10, by a mere touching of the at least one of the buttons of the other functionalities 26, the touch screens 30 of the display 27, and the combinations thereof.

The wrist-worn device 10 further includes a credit card function.

The credit card function of the other functionalities 26 is for scanning a credit card for use in receiving funds and for paying funds and for displaying credit card information on the display 27 without using the credit card and is activated by using only the wrist-worn device 10, by a mere touching of the at least one of the buttons of the other functionalities 26, the touch screens 30 of the display 27, and the combinations thereof.

The other functionalities 26 further include a battery interface. The battery interface of the other functionalities 26 is in electrical communication with the wrist-worn device 10, and is for being in electrical communication with batteries for powering the wrist-worn device 10.

In the alternative, the other functionalities 26 further include solar cells. The solar cells of the other functionalities 26 are in electrical communication with the wrist-worn device 10, and are for powering the wrist-worn device 10.

### Impressions

It will be understood that each of the elements described above or two or more together may also find a useful application in other types of constructions differing from the types described above.

While the embodiments of the present invention have been illustrated and described as embodied in a wrist-worn device for operating multiple remote-controlled devices and other functions wirelessly and for being self-contained so as not to need to be in communication with a smart phone and the like, nevertheless, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis, the foregoing will so fully reveal the gist of the embodiments of the present invention that others can by applying current knowledge readily adapt them for various applications without omitting features from the standpoint of prior art fairly constitute characteristics of the generic or specific aspects of the embodiments of the present invention.

The invention claimed is:

1. A wrist-worn device for wearing around a wrist of a user and for operating multiple remote-controlled devices and other functions wirelessly and without a need to be in communication with a smart phone and the like, said device comprising:
a) a band;
b) multiple remote-controlled device activators;
c) other functionalities; and
d) a display;
wherein said band is for wearing around the wrist of the user;
wherein said multiple remote-controlled device activators are disposed at said band;
wherein said multiple remote-controlled device activators are for operating the multiple remote-controlled devices wirelessly without the need to be in communication with the smart phone and the like;
wherein said other functionalities are disposed at said band;
wherein said other functionalities are for operating the other functions wirelessly without the need to be in communication with the smart phone and the like;
wherein said display is disposed at said band; and
wherein said display contains touch screens.

2. The wrist-worn device of claim 1, wherein said multiple remote-controlled device activators utilize at least one of buttons, said touch screens of said display, and combinations thereof to activate.

3. The wrist-worn device of claim 2, wherein said multiple remote-controlled device activators include a lock and unlock function.

4. The wrist-worn device of claim 3, wherein said lock and unlock function of said multiple remote-controlled device activators is for selectively locking and unlocking multiple locks using only said wrist-worn device, by a mere touching of said at least one of said buttons of said multiple remote-controlled device activators, said touch screens of said display, and said combinations thereof.

5. The wrist-worn device of claim 4, wherein said multiple locks of said lock and unlock function of said multiple remote-controlled device activators include at least one door of at least one of a house, an office, a car, a garage, and a gym locker.

6. The wrist-worn device of claim 2, wherein said multiple remote-controlled device activators include an on and off function.

7. The wrist-worn device of claim 6, wherein said on and off function of said multiple remote-controlled device activators is for selectively turning on and off multiple devices using only said wrist-worn device, by a mere touching of said at least one of buttons of said multiple remote-controlled device activators, said touch screens of said display, and said combinations thereof.

8. The wrist-worn device of claim 7, wherein said multiple devices of said on and off function of said multiple remote-controlled device activators include at least one of at least one TV, at least one computer, at least one AC, and at least one set of curtains.

9. The wrist-worn device of claim 8, wherein said on and off function of said multiple remote-controlled device activators selectively changes channels and monitor volume of said at least one TV of said multiple devices of said on and off function of said multiple remote-controlled device activators.

10. The wrist-worn device of claim 2, wherein said other functionalities utilize said at least one of said buttons, said touch screens of said display, and said combinations thereof to activate.

11. The wrist-worn device of claim 2, wherein said other functionalities include an enhanced Lifealert® function.

12. The wrist-worn device of claim 11, wherein said enhanced Lifealert® function of said other functionalities is for notifying Lifealert®, and additionally and simultaneously, is for notifying a designated person, using only said wrist-worn device.

13. The wrist-worn device of claim 12, wherein said designated person includes at least one of a family member and a close person, so as to allow said at least one of said family member and said close person to know if said enhanced Lifealert® function of said other functionalities has been activated so as to be able to be on top of any emergency situation immediately when something happens.

14. The wrist-worn device of claim 1, wherein said other functionalities include a medical history function.

15. The wrist-worn device of claim 14, wherein said medical history function of said other functionalities includes:
a) a port;
b) an internal memory device;
c) an external memory device; and
d) a remote flash drive;
wherein said internal memory device of said medical history function of said other functionalities is for storing updated medical history of the user;
wherein said internal memory device of said medical history function of said other functionalities is for storing previous medical history of the user, wherein the previous medical history of the user cannot be altered by anybody for ruling out possibility of fraudulent activity; and
wherein said remote flash drive would be placed in said wrist-worn device, which would be connected to a computer and information, medical or otherwise, could go back and forth between said remote flash drive and the computer, such as, information about staff, writing an essay, writing a novel, business work, work schedules, and power point presentations.

16. The wrist-worn device of claim 15, wherein said port of said medical history function of said other functionalities is disposed at said band; and
wherein said port of said medical history function of said other functionalities is in communication with said internal memory device of said medical history function of said other functionalities.

17. The wrist-worn device of claim 15, wherein said port of said medical history function of said other functionalities replaceably receives said external memory device of said medical history function of said other functionalities for transferring the updated medical history of the user thereto for interfacing with a computer for viewing, and for transferring, the updated medical history of the user.

18. The wrist-worn device of claim 15, wherein said updated medical history of the user includes at least one of EKG's, X-Rays, MRI results, medical diagnoses, medications prescribed, doctor's notes, and progress notes for viewing by a healthcare provider.

19. The wrist-worn device of claim 2, wherein said other functionalities include a tracking/locating function.

20. The wrist-worn device of claim 19, wherein said tracking/locating function of said other functionalities is for locating a lost item using only said wrist-worn device, by a mere touching of said at least one of said buttons, said touch screens of said display, and said combinations thereof.

21. The wrist-worn device of claim 20, wherein said lost item of said tracking/locating function of said other functionalities include at least one of a child, an adult, an IPhone, a wallet, a car that one forgot where said car of said lost item of said tracking/locating function of said other functionalities was parked.

22. The wrist-worn device of claim 1, wherein said other functionalities include a blind/visually impaired function.

23. The wrist-worn device of claim 22, wherein said blind/visually impaired function of said other functionalities have Braille characters thereon for assisting blind/visually impaired.

24. The wrist-worn device of claim 2, wherein said other functionalities include a bio scanner function.

25. The wrist-worn device of claim 24, wherein said bio scanner of said other functionalities is for preventing using said wrist-worn device by those not authorized to use said wrist-worn device and is activated by using only said wrist-worn device.

26. The wrist-worn device of claim 2, wherein said other functionalities include a smoke detector function.

27. The wrist-worn device of claim 26, wherein said smoke detector function of said other functionalities is for notifying when smoke is detected and is automatically activated by using only said wrist-worn device when high levels of smoke are detected.

28. The wrist-worn device of claim 2, wherein said other functionalities include a carbon monoxide detector function.

29. The wrist-worn device of claim 28, wherein said carbon monoxide detector function of said other functionalities is for notifying when carbon monoxide is detected and is automatically activated by using only said wrist-worn device when high levels of carbon monoxide are detected.

30. The wrist-worn device of claim 2, wherein said other functionalities include a radiation detector function.

31. The wrist-worn device of claim 30, wherein said radiation detector function of said other functionalities is for notifying when radiation is detected and is automatically activated by using only said wrist-worn device when high levels of radiations are detected.

32. The wrist-worn device of claim 2, wherein said other functionalities include a light function.

33. The wrist-worn device of claim 32, wherein said light function of said other functionalities is for illuminating dark and dimly lighted areas and is activated by using only said wrist-worn device, by a mere touching of said at least one of said buttons of said other functionalities, said touch screens of said display, and said combinations thereof.

34. The wrist-worn device of claim 2, wherein said other functionalities include a watch function.

35. The wrist-worn device of claim 34, wherein said watch function of said other functionalities is for displaying time, and is activated by using only said wrist-worn device, by a mere touching of said at least one of said buttons of said other functionalities, said touch screens of said display, and said combinations thereof.

36. The wrist-worn device of claim 2, wherein said other functionalities include a recorder function.

37. The wrist-worn device of claim 36, wherein said recorder function of said other functionalities is for recording sound, and is activated by using only said wrist-worn device, by a mere touching of said at least one of said buttons of said other functionalities, said touch screens of said display, and said combinations thereof.

38. The wrist-worn device of claim 2, wherein said other functionalities include an alarm function.

39. The wrist-worn device of claim 38, wherein said alarm function of said other functionalities is for activating an alarm connected thereto automatically if security is breached, and is for notifying an owner and law enforcement simultaneously, and is activated by using only said wrist-worn device.

40. The wrist-worn device of claim 38, wherein said alarm of said alarm function of said other functionalities includes a car alarm, a home alarm, and any additional alarm and security system connected to said wrist-worn device.

41. The wrist-worn device of claim 2, wherein said other functionalities include a radio function.

42. The wrist-worn device of claim 41, wherein said radio function of said other functionalities is for playing a radio, and is activated by using only said wrist-worn device, by a mere touching of said at least one of said buttons of said other functionalities, said touch screens of said display, and said combinations thereof and is connected to headphones via an auxiliary port.

43. The wrist-worn device of claim 2, wherein said other functionalities include a recorded book function.

44. The wrist-worn device of claim 43, wherein said recorded book function of said other functionalities is for allowing listening to a recorded book, and is activated by using only said wrist-worn device, by a mere touching of said at least one of said buttons of said other functionalities, said touch screens of said display, and said combinations thereof.

45. The wrist-worn device of claim 2, wherein said other functionalities include a timer function.

46. The wrist-worn device of claim 45, wherein said timer function of said other functionalities is for keeping track of time, and is activated by using only said wrist-worn device, by a mere touching of said at least one of said buttons of said other functionalities, said touch screens of said display, and said combinations thereof.

47. The wrist-worn device of claim 2, wherein said other functionalities include a compass function.

48. The wrist-worn device of claim 47, wherein said compass function of said other functionalities is for providing a compass, and is activated by using only said wrist-worn device, by a mere touching of said at least one of said buttons of said other functionalities, said touch screens of said display, and said combinations thereof.

49. The wrist-worn device of claim 2, wherein said wrist-worn device includes a credit card function.

50. The wrist-worn device of claim 49, wherein said credit card function of said other functionalities is for scanning a credit card for use in receiving funds and for paying funds and for displaying credit card information on said display without using the credit card and is activated by using only said wrist-worn device, by a mere touching of said at least one of said buttons of said other functionalities, said touch screens of said display, and said combinations thereof.

51. The wrist-worn device of claim 1, wherein said band is waterproof for protecting said multiple remote-controlled device activators, said other functionalities, and said display from any water damage.

52. The wrist-worn device of claim 1, wherein other functionalities include a battery interface;
wherein said battery interface of said other functionalities is in electrical communication with said wrist-worn device;
wherein said battery interface of said other functionalities is for being in electrical communication with rechargeable batteries for powering said wrist-worn device; and
wherein said battery interface of said other functionalities has a low battery indicator to prevent the rechargeable batteries from dying without notification so as to eliminate the dangers caused therefrom.

53. The wrist-worn device of claim 1, wherein other functionalities include solar cells;
wherein said solar cells of said other functionalities are in electrical communication with said wrist-worn device; and
wherein said solar cells of said other functionalities are for powering said wrist-worn device.
